(19) United States
(12) Patent Application Publication
(10) Pub. No.: US 2015/0127956 A1
(43) Pub. Date: May 7, 2015

(54) STORED DEVICE WITH PARTITIONS

(71) Applicant: Sage Microelectronics Corp., SARATOGA, CA (US)

(72) Inventors: Xiangxiong Lou, Hangzhou (CN); Hailuan Liu, Hangzhou (CN)

(73) Assignee: Sage Microelectronics Corp., SARATOGA, CA (US)

(21) Appl. No.: 14/070,340

(22) Filed: Nov. 1, 2013

(51) Int. Cl. H04L 9/08

(52) U.S. Cl. CPC H04L 9/0861
USPC 713/193; 726/5

(57) ABSTRACT

A storage device includes a disk controller and a non-volatile memory coupled to the disk controller and operable to save one or more passwords. The storage device further includes a media with more than one partition, the disk controller making each partition to be accessible to one or more users based on the saved one or more passwords.

### BACKGROUND

Various embodiment of the invention relate generally to storage devices and particularly to media employed by the storage devices.

Storage devices commonly employ media, such as disk media and flash memory. A popular storage device has become Universal Serial Bus (USB) flash disk. These devices are generally portable and when plugged into a computer, essentially become an additional storage device or medium for users and/or applications.

Security has become a hot issue in the recent decade and with it has come security concerns for storage devices. Oftentimes, sensitive information is saved in a storage device that is prone to problems if accessible to unwanted persons. Yet, the common and easy use of flash disks warrants access by common users to these devices.

Currently, security is addressed by assigning a password to the entire flash disk upon entry of which, the saved content of the flash disk (commonly referred to as “memory stick” or “thumb drive”) becomes accessible. However, there is no way to flexibly configure the flash disk other than the foregoing.

Accordingly, there is a need for storage devices employing media to be flexibly addressable.

### SUMMARY

Briefly, a storage device includes a disk controller and a non-volatile memory coupled to the disk controller and operable to save one or more passwords. The storage device further includes a media with more than one partition, the disk controller making each partition to be accessible to one or more users based on the saved one or more passwords.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a storage device 10, in accordance with an embodiment of the invention.

FIG. 2 shows further details of the disk controller 12, in accordance with another embodiment of the invention.

FIG. 3 shows the storage device 10 of FIG. 1 to be a USB flash disk with two partitions, in accordance with another embodiment of the invention.

FIG. 4 shows the storage device 10 of FIG. 1 to be a SATA interface hard disk with two partitions, in accordance with yet another embodiment of the invention.

### DETAILED DESCRIPTION OF EMBODIMENTS

Particular embodiments and methods of the invention disclose a storage device having a disk controller and a non-volatile memory coupled to the disk controller and operable to save one or more passwords. The storage device further includes a media with more than one partition, the disk controller making each partition to be accessible to one or more users based on the saved one or more passwords.

The following description describes a storage device with a media. The media is partially or wholly divided into partitions with distinct levels of security thereby increasing flexibility of use and security, as discussed below.

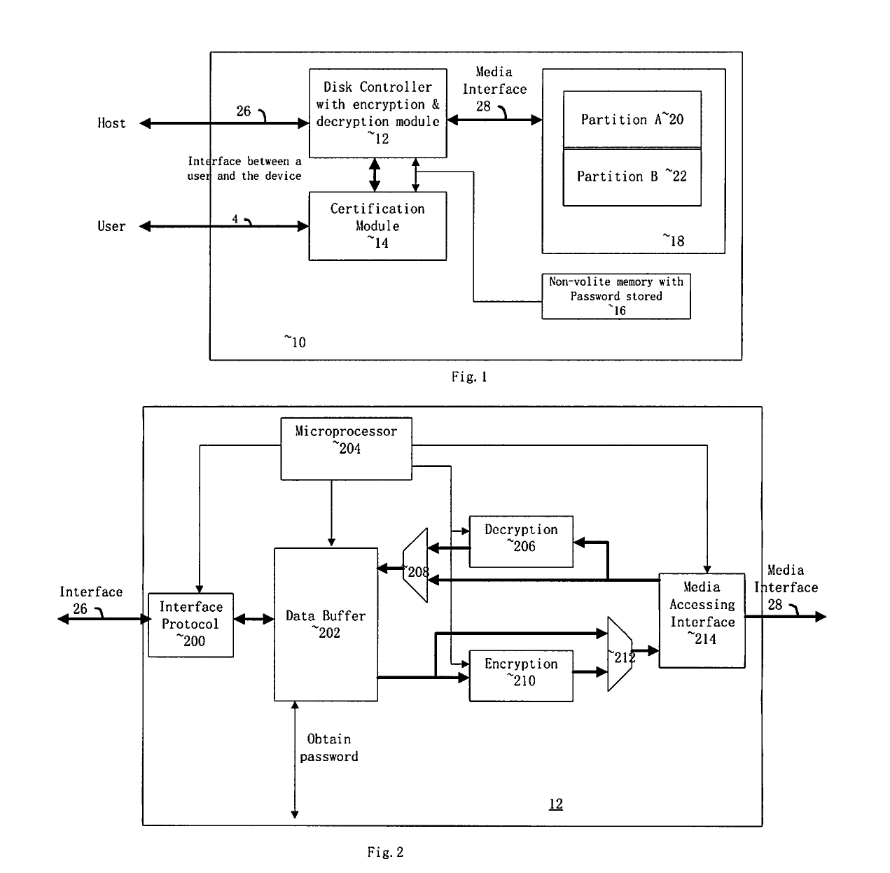

Referring now to FIG. 1, a storage device 10, is shown in accordance with an embodiment of the invention. The storage device 10 is shown to include a disk controller 12, a certification module 14, a non-volatile memory 16, and a media 18. The disk controller is shown coupled to a host through an interface 26. The disk controller 12 is also shown coupled to the module 14 and the non-volatile memory 16. The certification module 14 receives input from a user, for example, through a keyboard, fingerprint, voice, or other types of biometrics.

The disk controller 12 is further shown coupled to the media 18 through the media interface 28. As will be further evident below, the disk controller 12 is capable of encrypting and decrypting. The non-volatile memory 16 saves one or more passwords and the media 18 includes partition A 20 and partition B 22.

In some embodiments of the invention, the media 18 is a disk controller or a flash memory. The storage device 10 may be employed in a variety of applications one of which is a USB drive. The host with which the storage device 10 communicates through the interface 26 may be a hard disk or a flash card.

In exemplary embodiments, the interface 26 is SATA, IDE, SAS, USB, Security Disk (SD), or a multi-media card. In exemplary embodiments, the non-volatile memory 16 is flash memory, optical disk, or tape.

In operation, the certification module 14 receives input from a user that is used to authenticate the user. As previously noted, examples of such input are voice, biometrics, or keyboard strokes. Additionally, one or more passwords are provided by the user to the module 14. The module 14 communicates the received information from the user to the disk controller 12, which may or may not encrypt the information. The disk controller 12 causes storage of received passwords in the non-volatile memory 16. It is important to use non-volatile memory to store passwords because even upon the loss of power, the passwords are maintained.

In some embodiments of the invention, the non-volatile memory 16 is inside the disk controller 12. The disk controller 12 uses the passwords stored in the non-volatile memory 16 to unlock access to either the partition A 20 or the partition B 22 or both. That is, depending on the level of access allowed or assignment to the user, a distinct partition or both partitions of memory are made accessible to the user. However, locking out the user from accessing a particular partition, prevents the user from accessing the same. It is understood that while only two partitions are shown in the embodiment of FIG. 1, any number of desired partitioned may be employed.

Perhaps, a specific example will help better understand the role of the partitions of the media 18. In a commercial business, where a head person requires access to all information, the head person might be allowed to access any of the partitions A or B but an employee reporting to the head person might be assigned a lower level of access such as to only being able to access partition A. There are a slew of reasons for various assignments of security to various users. During operation, the head person, knowing the passwords that allow him/her access to the partitions A and B enters either password and the password is then received by the certification module. If access to the other partition is required, a different password is entered by the head person. These passwords, once noted by the disk controller 12, are indicators of which partitions are to be accessible by distinct users. For example, a password A can only access partition A 20 and password B can access both partitions A and B (20 and 22) or password B can only access partition B.

In a bypass mode, the password is always available to the users.

FIG. 2 shows further details of the disk controller 12, in accordance with another embodiment of the invention. The disk controller 12 is shown to include an interface protocol block 200, a data buffer 202, a microprocessor 204, an encryption block 210, a decryption block 206, a selector 208, a selector 212, and a media accessing interface 214.

The interface protocol block 200 is shown coupled to receive information from the host through the interface 26 and is further shown coupled to the data buffer 202 and the microprocessor 204. The data buffer 202 is shown coupled to receive the password(s) from the module 14 (in FIG. 1) and is shown coupled to the microprocessor 204, the selector 208, and the encryption block 210. The microprocessor 204 is further shown coupled to the encryption block 210 and the decryption block 206. The encryption block 210 is shown coupled to the selector block 212, which is shown coupled to the media accessing interface 214. Similarly, the decryption block 206 is shown coupled to the selector 208 and the media accessing interface 214. The output of the selector block 208 is shown coupled to the data buffer 202. The media accessing interface 214 is shown coupled to the selector block 208 and the data buffer 202 is shown coupled to the selector block 212. An exemplary implementation of each of the selector blocks 212 and 208 is a multiplexer.

In operation, under the direction of the host, the data buffer saves information provided through the interface 26 to the interface protocol 200. The data buffer 202 also saves passwords, obtained from the non-volatile memory 16 (in FIG. 1). Under the direction of the microprocessor 204, the selector block 212 either passes through data from the data buffer 202 or from the encryption block 210. The encryption block 210 encrypts the data, including the password. Examples of encryption codes utilized by the encryption block 210 are AES, GOST, ECC, Zuchongzhi, RSA, DES/3DES, or other suitable encryption schemes. Upon receiving encrypted data (including the password), the decryption block 206 decrypts this information and provides the decrypted information to the selector block 208, which then passes along the decrypted information to the data buffer 202.

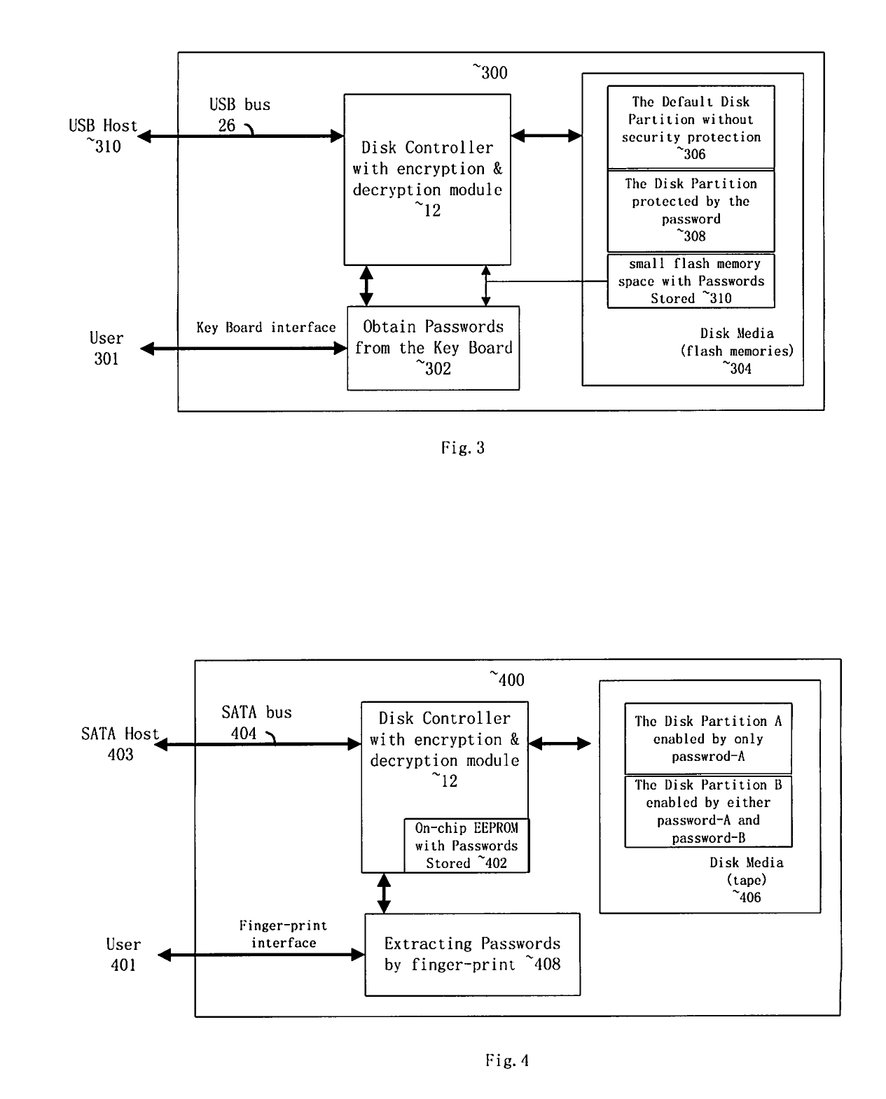

FIG. 3 shows the storage device 300, analogous to the storage device 10 of FIG. 1, to be a USB flash disk with two partitions, in accordance with another embodiment of the invention. In an exemplary embodiment and method, the user 301 enters information, such as a password, through a keyboard. The password is saved in the block 302. Storage is a disk media 304, which in an embodiment of the invention is flash memory. The disk media 304 is shown to include a default disk partition without any kind of security protection, i.e. partition 306, and a disk partition protected by the password of the block 302, i.e. partition 308. Further included in the disk media 304 is a flash memory space 310 with a list of stored passwords. The space 310 saves all of the passwords used by the storage device 300. The interface 26 is a USB bus in the embodiment of FIG. 3.

FIG. 4 shows the storage device 400, analogous to the storage device 10 of FIG. 1, to be a SATA interface hard disk with two partitions, in accordance with yet another embodiment of the invention. In FIG. 4, the module 12 is shown to include an on-chip EEPROM with passwords, i.e. block 402. The block 402 saves the passwords used by the storage device 400 in EEPROM. The block 408 extracts the passwords from the user 401, which are in the form of fingerprint. The disk media 406 may be a tape or other types of disk media. The disk media 406 is shown to include partition A and partition B. Partition A, in this example, is enabled by a password A only whereas partition B is enabled by either password A or password B.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What we claim is:

1. A method of partitioning memory comprising:
receiving a first password;
receiving a second password;
based on the first password, determining a first partition of a non-volatile memory to be accessible to a first user;
based on the second password, determining the first partition to be accessible to the second user;
based on the second password, allowing access to a second partition of the non-volatile memory by the second user; and
preventing access to the second partition by the first user.

2. The method of partitioning of claim 1, further including encrypting and decrypting the first password.

3. The method of partitioning of claim 2, wherein using AES, GOST, ECC, Zuchongzhi, RSA, or DES/3DES for encrypting.

4. The method of partitioning of claim 1, further including encrypting and decrypting the second password.

5. The method of partitioning of claim 4, wherein using AES, GOST, ECC, Zuchongzhi, RSA, or DES/3DES for encrypting.

6. A storage device comprising:
a disk controller;
a non-volatile memory coupled to the disk controller and operable to save one or more passwords; and
a media including more than one partition, the disk controller making each partition to be accessible to one or more users based on the saved one or more passwords.

7. The storage device, as recited in claim 6, further including a certification module coupled to the disk controller and responsive to the user, the certification module operable to certify the user.

8. The storage device, as recited in claim 7, wherein the certification module is responsive to biometric, voice, or keyboard entries from the user.

9. The storage device, as recited in claim 1, wherein the disk controller is coupled to the host through an interface.

10. The storage device, as recited in claim 9, wherein the interface is SATA, IDE, SAS, PCI/PCIE, SCSI or USB.

11. The storage device, as recited in claim 1, further including an encryption block coupled to the data buffer and the media and operable to selectively encrypt the first password and second password.

12. The storage device, as recited in claim 11, wherein the encryption block is operable to use AES, GOST, ECC, Zuchongzhi, RSA, or DES/3DES encryption schemes.

13. The storage device, as recited in claim 11, further including a decryption block coupled to the data buffer and the media and operable to selectively decrypt the first password and second password.

14. The storage device, as recited in claim 1, wherein the non-volatile memory is located internally to the microprocessor.

15. The storage device, as recited in claim 1, wherein the non-volatile memory is located externally to the microprocessor.

16. The storage device, as recited in claim 1, wherein the non-volatile memory is flash memory, optical disk, or tape.

17. The storage device, as recited in claim 1, wherein the storage device is a universal serial bus (USB) flash disk.

18. The storage device, as recited in claim 1, wherein the storage device is a hard disk with one of the following interface: SATA IDE, SCSI, SAS, PCI/PCIE.
